(19) United States
(12) Patent Application Publication
(10) Pub. No.: US 2012/0150502 A1
(43) Pub. Date: Jun. 14, 2012

(54) SIMULATION METHOD OF FLYING TRAJECTORY OF BALL

(75) Inventors: Seong Min BAEK, Daejeon (KR); Myung Gyu KIM, Daejeon (KR); Jong Sung KIM, Daejeon (KR); Il Kwon JEONG, Daejeon (KR); Byoung Tae CHOI, Daejeon (KR)

(73) Assignee: ELECTRONICS AND TELECOMMUNICATIONS RESEARCH INSTITUTE, Daejeon (KR)

(21) Appl. No.: 13/288,378

(22) Filed: Nov. 3, 2011

(30) Foreign Application Priority Data
Dec. 9, 2010 (KR) 10-2010-0125841

(51) Int. Cl. G06F 17/10

(52) U.S. Cl. 703/2

(57) ABSTRACT

Disclosed is a simulation method of a flying trajectory of a ball which flies while rotating. More particularly, An exemplary embodiment of the present invention provides an accurate simulation method of a flying trajectory of a flying ball by reflecting a roughness feature of the surface of the ball in which the flying trajectory of the ball is simulated by calculating drag force, lifting force, and gravity applied to the ball which files while rotating and the drag force and the lifting force are adjusted by a function for calculating air density and a function associated with a change in the force of wind.

### CROSS-REFERENCE TO RELATED APPLICATIONS

This application claims priority to and the benefit of Korean Patent Application No. 10-2010-0125841 filed in the Korean Intellectual Property Office on Dec. 9, 2010, the entire contents of which are incorporated herein by reference.

### BACKGROUND OF THE INVENTION

1. Field of the Invention

The present invention relates to a simulation method of a flying trajectory of a ball flying while rotating. More particularly, the present invention relates to a method of calculating an accurate flying distance of a ball moving while rotating and relates to a method of accurately simulating a flying trajectory of the ball on the basis of aerodynamics when a user hits or throws the ball.

Further, the present invention relates to a method of calculating the density of air by using an intuitive parameter and applying the acquired density to a simulation.

In addition, the present invention relates to a method of applying the effect of actually similar wind to a game.

Besides, the present invention relates to a method of causing various changes in a flying trajectory according to a roughness feature of the surface of the ball.

2. Description of the Related Art

In recent years, a plurality of devices capable of playing a game by using an indoor ball such as a screen golf, and the like have been provided and a lot of methods for improving reality have appeared. In order to improve reality like reality in the devices, accurately acquiring the initial speed and direction, and rotation speed in which a ball flies and estimating the flying distance of the ball on the basis of the initial speed and direction, and rotation speed to display the estimated flying distance are evaluated as the very important factors.

However, most devices concentrate on acquiring an initial state in which the ball flies and there is a problem in that a simulation method of a flying trajectory is not accurate. That is, force acting on the ball which flies while rotating at a high speed is known as drag force, lifting force, and gravity, but in the related art, accurately applying the forces is insufficient. The state of air in a virtual environment should be considered in order to acquire the drag force and the lifting force and since air density and influence of wind which are factors affecting the drag force and the lifting force are generally processed as mere parameters in a game up to now, diverse variables depending on the location of the ball and the influence of air cannot be reflected.

In particular, in calculating the drag force, a drag coefficient is processed as a constant term in the virtual game and in addition, the roughness feature of the surface of the ball serves as a principal variable changing a drag coefficient, but in some studies, the feature is merely analyzed through a test and the feature is rarely applied to the game.

Accordingly, in the present invention described below, a realistic flying simulation of the ball which moves while rotating and a method capable of simulating a movement trajectory change depending on changes of various parameters will be suggested.

### SUMMARY OF THE INVENTION

The present invention has been made in an effort to provide a method of accurately simulating a flying trajectory on the basis of aerodynamics by receiving the initial states (initial movement speed and direction, and rotation speed) of a ball.

Further, the present invention has been made in an effort to provide an intuitive and accurate simulation method by calculating the density of air depending on a change in the state of air such as temperature, humidity, altitude, and the like and applying the calculated air density to a change in a flying trajectory of a ball. In addition, the present invention has been made in an effort to provides a method of considering a change in strength of wind depending on the height of a ball and applying the considered change to a ball flying trajectory simulation. Besides, the present invention has been made in an effort to provide a method of changing drag force depending on a roughness feature and accurately simulating the flying trajectory of the ball by applying a roughness feature of the surface of the ball as a parameter.

However, the object of the present invention is not limited to the above description and undescribed other objects will be able to be clearly appreciated to those skilled in the art from the following description.

An exemplary embodiment of the present invention provides a simulation method of a flying trajectory of a ball which flies while rotating that includes a function of calculating a lift coefficient giving an effect in which the rotating ball rises and a function of calculating a drag coefficient by friction with air, and provides a function of calculating the density of the air required to calculate a drag force and a lifting force.

Herein, the air density calculating function receives temperature, humidity, and an altitude as parameters.

Further, a function associated with a change in the force of wind depending on the height of the ball is provided in order to apply a realistic wind effect.

Lastly, a function of adjusting the drag coefficient depending on the roughness of the ball surface is provided. Accordingly, when force applied to the rotating ball is acquired, acceleration is acquired according to Newton's law of motion and the location of the ball can be accurately simulated by using a Fourth-order Runge-Kutta method.

According to exemplary embodiments of the present invention, it is possible to acquire a use satisfaction level for a sports game using a ball by improving reality to players who play a virtual game by accurately estimating the flying distance of a rotating ball by accurately simulating a flying trajectory of a ball which rotates at a high speed and applying diverse air changing conditions (temperature, humidity, the altitude of a field, and wind) and a change in roughness feature of the surface of the ball which may occur in an actual field.

### BRIEF DESCRIPTION OF THE DRAWINGS

FIG. 1 is a diagram showing a simulation method of a flying trajectory according to an exemplary embodiment of the present invention;

FIG. 2 is a graph showing an example of a change in a drag coefficient depending on a Reynolds number;

FIG. 3 is a graph showing an example of a change in force of a wind depending on a height;

FIG. 4 is a graph showing an example of a drag coefficient depending on a dimple feature (a dimple size);

FIG. 5 is a graph showing an example of a drag coefficient depending on a dimple feature (a dimple depth); and

FIG. 6 is a graph showing an example of a drag coefficient depending on a dimple feature (the number of dimples).

### DETAILED DESCRIPTION OF THE EMBODIMENTS

Hereinafter, exemplary embodiments of the present invention will be described in detail with reference to the accompanying drawings. In this description, when any one element is connected to another element, the corresponding element may be connected directly to another element or with a third element interposed therebetween. First of all, it is to be noted that in giving reference numerals to elements of each drawing, like reference numerals refer to like elements even though like elements are shown in different drawings. The components and operations of the present invention illustrated in the drawings and described with reference to the drawings are described as at least one exemplary embodiment and the spirit and the core components and operation of the present invention are not limited thereto.

Hereinafter, the detailed description of the present invention will be disclosed.

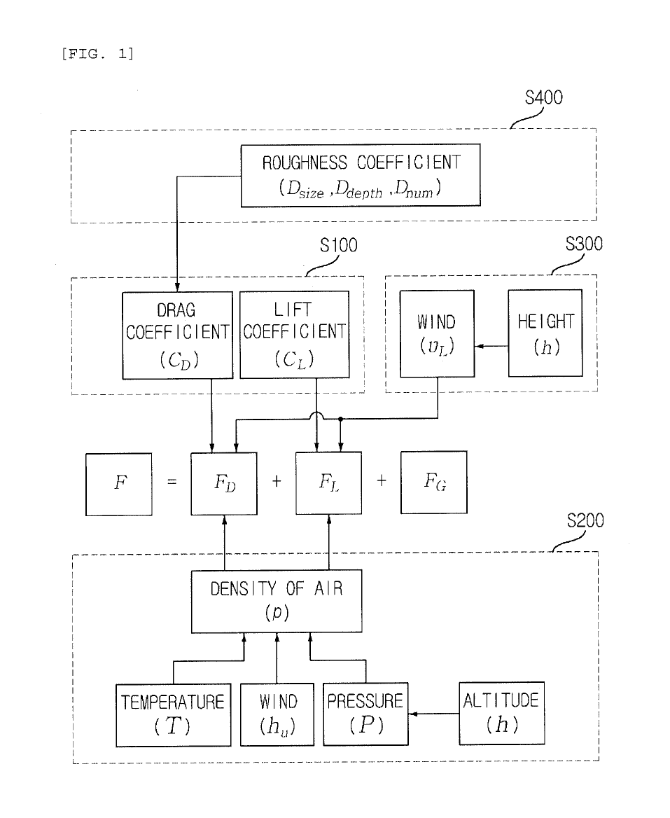

FIG. 1 is a diagram showing a simulation method of a flying trajectory according to an exemplary embodiment of the present invention.

Force which a flying ball receives is the sum of drag force, lifting force, and gravity and is defined by Equation 1.

F=F_{D}+F_{L}+F_{G} [Equation 1]

where, F_{D} represents drag force F_{drag}, F_{L} represents lifting force F_{lift}, and F_{G} represents gravity F_{gravity}.

That is, in the flying trajectory simulation method according to the exemplary embodiment of the present invention, the acceleration of a ball is acquired from Equation 1 and a fourth-order Runge-Kutta method is applied to simulate the velocity and location of the ball.

Hereinafter, a method for determining each of the factors of Equation 1 will be described.

The lifting force of a rotating ball, lifting force is defined by Equation 2.

$$\begin{matrix}[ Equation 2 ] & \\ {F}_{L} = \frac{1}{2} {C}_{L} ρ A \vert {v}_{b}^{2} \vert & \end{matrix}$$

where, ρ represents the density of air, A represents the cross section of the ball, ν_{b} represents the velocity of the ball, and C_{L} represents a lift coefficient.

The lift coefficient C_{L} as the factor for determining how much degree of a lifting effect of the rotating ball is acquired is defined by Equation 3.

$$\begin{matrix}[ Equation 3 ] & \\ {C}_{L} = - 0.05 + \sqrt{0.0025 + 0.36 \frac{R \vert w \vert}{\vert {v}_{b} \vert}} {F}_{L} = \frac{1}{2} {C}_{L} ρ A \vert {v}_{b}^{2} \vert & \end{matrix}$$

where, R represents the radius of the ball, ν_{b} represents the velocity of the ball, and ω represents □ the angular velocity of the ball.

That is, the lift coefficient is defined as a function of the speed of the ball and the angular speed of the ball, and as a result, the faster the ball rotates, the more the lifting effect is.

Next, force by air resistance, drag force is defined by Equation 4.

$$\begin{matrix}[ Equation 4 ] & \\ {F}_{D} - \frac{1}{2} {C}_{D} ρ A \vert {v}_{b}^{2} \vert & \end{matrix}$$

where, ρ represents the density of air, A represents the cross section of the ball, ν_{b} represents the velocity of the ball, and C_{D} represents a drag coefficient.

The drag coefficient C_{D} determines the resistance of air acting on the flying ball and the drag coefficient C_{D} is defined by Equation 5.

$$\begin{matrix}[ Equation 5 ] & \\ {C}_{D} = {C}_{0} \cdot ( - 2.1 {e}^{- 0.12 ( D ( Re ) + S + 0.35 )} + 8.9 {e}^{- 0.22 ( D ( Re ) + 0.35 )} ) \\ D ( Re ) = \{ \begin{matrix}{K}_{1} + {C}_{d 1} {K}_{1} - 1 & ( Re < {Re}_{σ} ) \\ {K}_{2} + {C}_{d 1} {K}_{2} - 0.0225 {C}_{d 2} - 1 & ( otherwise )\end{matrix} \\ where , \\ {C}_{0} = 0.21 , {Re}_{cr} = 6 \times {10}^{4} \\ {K}_{1} = {ReC}_{d 3} , {K}_{2} = {K}_{1} - {C}_{d 2} \\ {C}_{d 1} = 0.25 , {C}_{d 2} = ( Re - {Re}_{cr} ) {C}_{d 3} , {C}_{d 3} = 0.0001 \\ Range ( 4 \times {10}^{4} \sim 2.2 \times {10}^{5} ) & \end{matrix}$$

where, Re represents the Reynolds number and is defined by

$$Re = \frac{2 R \vert {v}_{b} \vert}{v} .$$

That is, the Reynolds number may be expressed by a ratio between force by inertia and force by viscosity. Herein, viscosity y is acquired by Equation 6.

$$\begin{matrix}[ Equation 6 ] & \\ v = \frac{μ}{ρ} & ( a ) \\ μ = {μ}_{0} \frac{0.555 {T}_{0} + C}{0.555 T + C} {( \frac{T}{{T}_{0}} )}^{\frac{3}{2}} & ( b )\end{matrix}$$

where, the viscosity represents kinematic viscosity coefficient ν and the kinematic viscosity coefficient may be acquired by a ratio between dynamic or absolute viscosity coefficient μ and density ρ [Equation 6-a].

The dynamic or absolute coefficient may be expressed by reference temperature (° R, degrees Rankine) T₀, current temperature (° R, degrees Rankine) T, a Sutherland's constant C, and reference viscosity coefficient μ₀ [Equation 6-b].

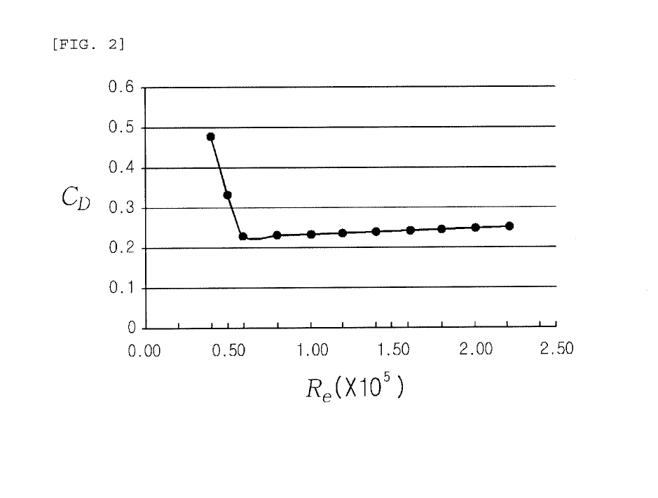

That is, the drag coefficient rapidly decreases at the Reynolds number of 4*10⁴ to 6*10⁴ and thereafter, gradually increases as the Reynolds number increases. As shown in FIG. 2 showing the relationship between the drag coefficient and the Reynolds number expressed through Equation 5, when the Reynolds number enters a critical regime, the drag coefficient rapidly decreases and thereafter, slightly increases. Therefore, it can be found that the function for calculating the drag coefficient by Equation 5 normally operates.

When Equations 1 to 6 are applied, a flying trajectory similar to an actual flying trajectory can be calculated to some degree. However, in an actual world, when the ball flies, the flying distance of the ball is associated with the state of air (weather, and the like). For example, as the temperature increases, the flying distance increases and as the humidity decreases, the flying distance also increases. In order to apply the effect to the game, calculation for the state of air is required.

That is, even in the related art, although the air density was considered, since the air density itself was directly inputted as a parameter, it could not be intuitive. Therefore, according to the exemplary embodiment of the present invention, an air density calculating function is applied in order to express a change in a flying trajectory depending on the air state. Further, according to the exemplary embodiment of the present invention, by inputting parameters such as temperature, humidity, altitude, and the like which a user can easily know, accurate air density is calculated and the calculated air density is applied to the simulation.

Hereinafter, a method of applying a method of applying an influence by the air density to the flying trajectory simulation according to the exemplary embodiment of the present invention will be described in detail.

$$\begin{matrix}[ Equation 7 ] & \\ ρ = 3.483740 \frac{P}{ZT} ( 1 - 0.3780 {x}_{v} ) & \end{matrix}$$

Equation 7 is a form applying an equation of air density presented by the Bureau International des Poids et Measures (BIPM). Herein, P represents pressure, T temperature (° K), χ_{ν} represents the function of humidity, and Z represents the function of pressure, temperature, and humidity.

$$\begin{matrix}[ Equation 8 ] & \\ P = {P}_{b} {e}^{\frac{- aMh}{{R}^{′} {T}_{b}}} & \end{matrix}$$

Equation 8 is used to acquire pressure and wherein, h represents the altitude of the corresponding location on the basis of a sea level and since basic coefficients (static pressure P_{b}, molar mass of air M, gas constant R*, and reference temperature T_{b}) are determined, the pressure can be calculated by the altitude.

When the density is acquired by using Equations 7 and 8, as the temperature is changed, the humidity is changed, or the altitude is changed, the density is changed to cause the drag force and the lifting force to change, thereby acquiring an effect in which the flying distance of the ball is changed.

Hereinafter, a method of applying the influence of the wind by the air condition to the flying trajectory simulation according to the exemplary embodiment of the present invention will be described in detail.

As described above, the air condition includes the influence of the wind. Although the force of the wind is often calculated as a constant term in a virtual game, the force of the wind actually depends on the height. The force of the wind is acquired by Equation 9.

$$\begin{matrix}[ Equation 9 ] & \\ \begin{matrix}\vert {v}_{2} \vert \\ \vert {v}_{1} \vert\end{matrix} = {( \begin{matrix}{h}_{2} \\ {h}_{1}\end{matrix} )}^{α} \\ α = 0.37 - {0.088}_{1} ln ( {v}_{ω 0} ) & \end{matrix}$$

where, ν₁ represents the velocity of the wind at height h₁ and ν₂ represents the velocity of the wind calculated at height h₂.

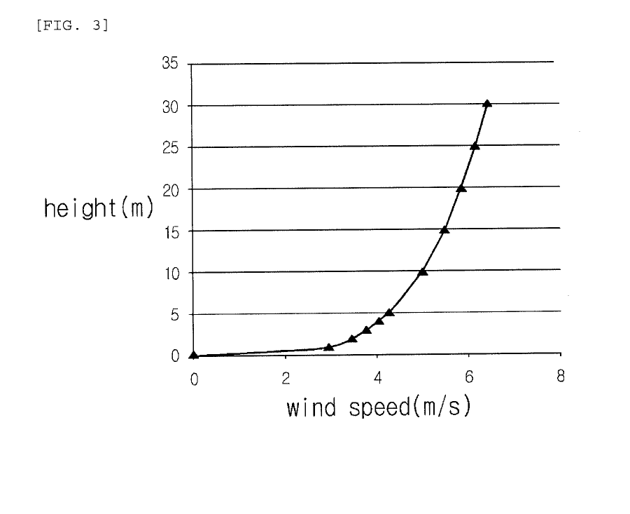

The force of the wind increases as the height increases and the force is not largely changed when the height reaches a predetermined height. The relationship between the height and the force of the wind is shown in FIG. 3.

In order to apply the influence of the wind, the velocity ν_{b} of the ball as described above is converted into a relative velocity for the wind ν₂, which is calculated. That is, the relative velocity of the ball in respects to the wind is shown in Equation 10.

νᵣ=ν_{b}−ν₂ [Equation 10]

Where, ν_{b} represents the velocity of the ball and ν₂ represents the velocity of the wind.

That is, νᵣ is used to acquire the velocity of the ball instead of ν_{b} as shown in Equation 10 when calculating the drag force F_{D} and the lifting force F_{L}. In this case, ν₂ represents the velocity of the wind depending on the height of the ball. In such a case, for example, when an adverse wind is blown, the relative speed of the ball increases, and as a result, the lifting force and the drag force increase, such that the ball flies higher and flies shorter. Therefore, a realistic wind effect can be acquired.

Next, a method of reflecting the roughness feature of the surface of the ball in order to simulate the flying trajectory of the ball which flies while rotating according to the exemplary embodiment of the present invention will be described. In an example described below, although it will be described on the assumption that the roughness feature of the surface of the ball is a dimple which is the surface feature of a golf ball, it is exemplary for convenience of description and it should be noted that the roughness feature can be easily modified and applied to even other balls.

A change in drag coefficient depending on the roughness feature of the surface of the ball is calculated for each of the following three types. According to the exemplary embodiment of the present invention, the roughness feature will be described as the dimple which is the surface feature of the golf ball.

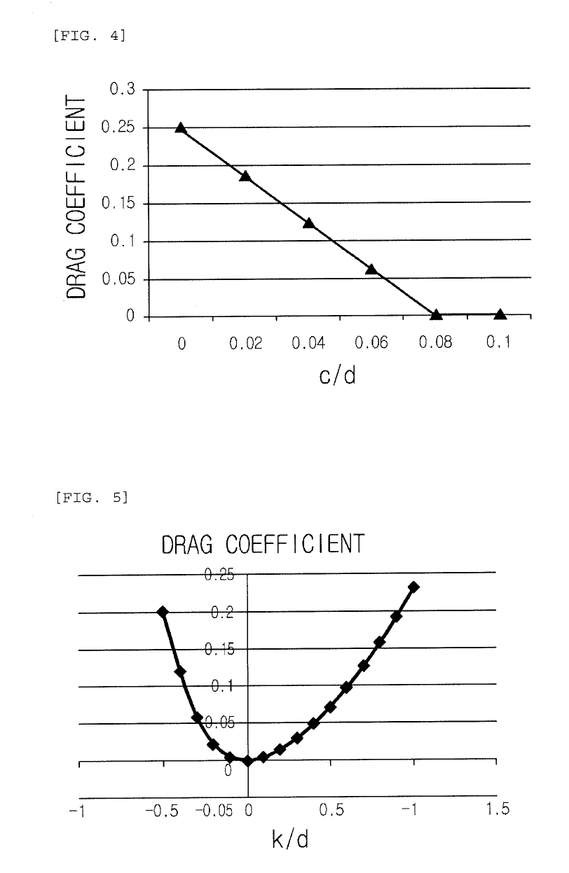

A first parameter of the roughness feature is the size (diameter, c) of the dimple on the surface of the ball. In the above description, as the diameter of the dimple increases, the drag coefficient decreases. Therefore, according to the exemplary embodiment of the present invention, a new model is created on the basis of the characteristic and represented as Equation 11 and a graph with the drag coefficient depending on a dimple size ratio (a ratio of the diameter of the dimple to the diameter of the ball, c/d, where, d represents the diameter of the ball and c represents the diameter of the dimple) is shown in FIG. 4.

$$\begin{matrix}[ Equation 11 ] & \\ \begin{matrix}{D}_{size} = {R}_{1} * ( - 3.125 * ( c / d ) + 0.25 ) , & ( c / d < 0.08 ) \\ = 0 , & ( c / d ≧ 0.08 )\end{matrix} & \end{matrix}$$

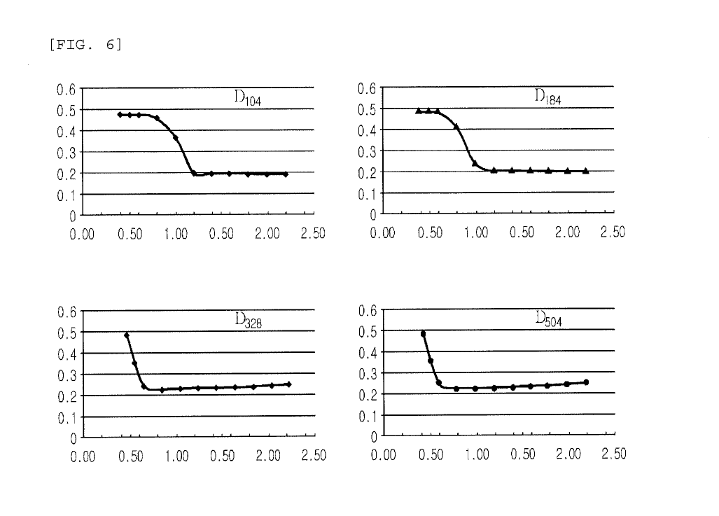

A second parameter of the roughness feature is the depth k of the dimple. As the depth of the dimple increases, the drag coefficient decreases and thereafter, when the depth reaches a predetermined depth (k/d is the minimum between 0.004 and 0.005), the drag coefficient increases again. Accordingly, according to the exemplary embodiment of the present invention, a model having the characteristic is presented as shown in Equation 12 and a graph with the drag coefficient depending on a dimple depth ratio (a ratio of the dimple depth to the diameter of the ball, k/d) is shown in FIG. 5.

Y₁=A₁X₁²+B₁X₁,(A₁=0.9295,B₁=0.06474)

Y₂=A₂X₂²+B₂X₂,(A₂=0.2326,B₁=−0.00263)

D_{depth}=R₂*(Y₁*K₁+Y₂*(1−K₁))

kd=k/d*100

K₁=Normalize(Power((kd−0.5)²,0.1)*SIGN(kd−0.5)) [Equation 12]

D_{size} and D_{depth} acquired by Equations 11 and 12 are added to the drag coefficient C_{D} acquired above. In this case, R₁, R₂ may be adjusted according to the importance of the coefficient.

A third parameter of the roughness feature is the number of dimples. In an experiment, as the number of dimples increases, the drag coefficient rapidly decreases at the smaller Reynolds number. However, when the number of dimples is more than a predetermined number (approximately 330), the change of the drag coefficient makes little difference. However, as the number increases, the drag coefficient slightly increases after a critical regime. Therefore, according to the exemplary embodiment of the present invention, a model having the characteristic is presented in Equation 13 and Table 1 and the relationship between the number of dimples and the Reynolds number is shown in FIG. 6.

K₁=K₁−Dₙ, K₂=K₂−Dₙ [Equation 13]

TABLE 1

| Num. | 0.4 | 0.5 | 0.6 | 0.8 | 1.0 | 1.2 | 1.4 | 1.5 | 1.8 | 2.0 | 2.2 | ×10⁴ |
|---|---|---|---|---|---|---|---|---|---|---|---|---|
| 104 | 0 | 1.25 | 2 | 1.9 | 1.2 | −0.5 | −0.55 | −0.6 | −0.65 | −0.7 | −0.75 | |
| 184 | 0 | 1.25 | 2 | 1.5 | 0 | −0.4 | −0.45 | −0.5 | −0.55 | −0.6 | −0.65 | |
| 328 | 0 | 0 | 0 | 0 | 0 | 0 | 0 | 0 | 0 | 0 | 0 | |
| 504 | 0 | 0.2 | 0.2 | 0.1 | 0.1 | 0.1 | 0.1 | 0.1 | 0.1 | 0.1 | 0.1 | |

In Equation 13, K₁ and K₂ are variables used at the time of acquiring the drag coefficient in Equation 5. When the values are adjusted, a drag coefficient function on which the characteristic in the number of dimples is reflected is shown. Dₙ is shown in Table 1 and the relationship with the Reynolds number is adjusted depending on the number of dimples. In the case of the number of dimples in a predetermined number, a proper coefficient may be acquired by interpolation between the respective drag coefficients.

Consequently, the force which the flying ball receives is the sum of the drag force, the lifting force, and the gravity and is defined by Equation 1 described above.

F=F_{drag}+F_{lift}+F_{gravity}

When the acceleration of the ball is calculated from Equation 1 by reflecting the function for calculating the air density, the function associated with the change in the force of the wind, and the roughness feature of the surface of the ball and the fourth-order Runge-Kutta method is applied, the flying trajectory of the ball which flies while rotating can be accurately simulated.

As described above, according to the exemplary embodiment of the present invention, all changes of air such as temperature, humidity, altitude, wind, and the like in order to acquire the force applied to the ball and the roughness feature of the ball is also reflected, such that reality is improved and reality is improved in the virtual game through various changes by reducing an error between an actual flying distance and the flying distance through the simulation when the ball is hit or thrown.

As described above, the exemplary embodiments have been described and illustrated in the drawings and the specification. Herein, specific terms have been used, but are just used for the purpose of describing the present invention and are not used for defining the meaning or limiting the scope of the present invention, which is disclosed in the appended claims. Therefore, it will be appreciated to those skilled in the art that various modifications are made and other equivalent embodiments are available. Accordingly, the actual technical protection scope of the present invention must be determined by the spirit of the appended claims.

What is claimed is:

1. A simulation method of a flying trajectory of a ball, wherein the flying trajectory of the ball is simulated by calculating drag force, lifting force, and gravity applied to the ball and the drag force and the lifting force are adjusted by a function for calculating air density and a function associated with a change in the force of wind.

2. The method of claim 1, wherein the drag force is adjusted by further reflecting a roughness feature of the surface of the ball.

3. The method of claim 2, wherein a lift coefficient used to calculate the lifting force is determined by reflecting the rotation rate of the ball and a drag coefficient used to calculate the drag force is determined by reflecting the Reynolds number of the ball.

4. The method of claim 3, wherein the function for calculating the air density is determined by using at least one of temperature and humidity parameters of air, and an altitude parameter as an input variable, and the lifting force and the drag force are adjusted by the determined function for calculating the air density.

5. The method of claim 3, wherein the function associated with the change in the force of wind is determined by using the height parameter of the ball as an input variable, and the lifting force and the drag force are adjusted by the determined function associated with the change in the force of wind.

6. The method of claim 3, wherein the roughness feature of the surface of the ball is a feature of a dimple of the ball surface.

7. The method of claim 6, wherein the feature of the dimple is determined by at least one of the size and depth of the dimple, and the number of dimples.

8. The method of claim 7, wherein the drag coefficient used to calculate the drag force is adjusted according to the feature of the dimple.

9. The method of claim 8, wherein the flying trajectory simulating method is applied to a virtual game using the ball.
